(19) United States
(12) Patent Application Publication
(10) Pub. No.: US 2008/0240718 A1
(43) Pub. Date: Oct. 2, 2008

(54) Free-Space Communications System and Method

(76) Inventors: Walter V. Werner, Pittsford, NY (US); Park E. Hays, Albuquerque, NM (US)

Correspondence Address: BOND, SCHOENECK & KING, PLLC, 10 BROWN ROAD, SUITE 201, ITHACA, NY, 14850-1248, US

(21) Appl. No.: 11/695,142

(22) Filed: Apr. 2, 2007

(51) Int. Cl. H04J 14/02

(52) U.S. Cl. 398/96

(57) ABSTRACT

Embodiments of the invention are directed to a free-space communications system, a signal transmission platform for a free-space communications system, and a method for free-space communications, that advantageously provide or have the potential to provide measurable improvements in free-space communications over a turbulent atmospheric transmission path. A principal feature of all of the embodiments disclosed herein is the generation of a pseudo-non-diffracting communications signal transmission beam, referred to herein as a ‘non-diffracting signal transmission beam’. A realizable embodiment of such a non-diffracting signal transmission beam known in the art is a Bessel beam. A free-space communications system includes a communications signal transmitter platform that ultimately can generate a particularly specified transmission signal waveform, which is a non-diffracting signal transmission beam. The free-space communications system also includes a communications signal receiver platform that is located along a free-space communications signal transmission path. By modifying the signal light source from Gaussian to Bessel or other non-diffracting type beams, intensity stability under turbulence is improved. This passive technique, by virtue of increased intensity stability, may help to maintain bit error rate performance under turbulence.

### FIELD OF THE INVENTION

Embodiments of the invention are directed to a free-space communications system and method, and more particularly, to a free-space communications system, signal transmission platform and free-space communications method that offer improved communications performance over a turbulent free-space transmission medium.

### DESCRIPTION OF RELATED ART

Free-space optical communications, alternatively referred to as optical wireless transmission or fiber-less optical transmission, and by analogous monikers, is simple in concept: a communications signal in the form of a narrow laser beam is sent from a transmitter to a receiver over a straight line optical path through the atmosphere. Beam steering components may be utilized to bend or direct the optical transmission path, but for the purpose of the invention embodiments described herein, the communications system can be viewed as a line-of-sight system. Unlike a fiber-based communications system, in which an optical fiber waveguide provides a relatively unobstructed and protected path for the transmission signal to the receiver platform, an exemplary signal-carrying infrared laser beam propagating over a free-space signal transmission path close to the earth's surface will encounter atmospheric conditions that reduce the ‘quality’ of the received communications signal. Communications signal quality (expressed, for example, in terms of beam intensity, bit error rate, signal to noise ratio, and other metrics known by those skilled in the art) may, at best, be degraded due to geometric effects as the signal laser beam spreads out over an increasing transmission path length. At worst, no discernable signal may be received due to the effects of absorption, scattering, scintillation, phase disruption, and others. The term “turbulence” will be used herein to refer to all of the various artifacts in the free-space atmospheric transmission path that operate to shorten the operable transmission path between transmitter and receiver and/or attenuate the quality of the communication signal detectable at the receiver.

Several approaches for mitigating the effects of turbulence in a free-space communications system are known. One approach is based on the principle of diversity. The concept of diversity is to transmit the signal over several independent routes, so to speak, thus producing independent signal replicas that can be selectively detected or used in combination to optimize the signal quality at the receiver end of the communications system. Diversity techniques include time diversity, frequency diversity, spatial diversity and polarization diversity.

Another approach for mitigating the effects of turbulence in free-space communications involves the use of adaptive optics. In an illustrative sense, the turbulence-aberrated phase of the propagating beam wavefront is detected through a feedback loop that controls the surface shape of a deformable mirror to compensate for the turbulence-induced phase fluctuations.

Another mitigation approach relies upon innovative antenna technology coupled with sophisticated statistical analyses of the transmission characteristics to optimize the quality of the detected communication signal.

These techniques and variations of each that are known in the art, and which are successful to varying degrees in increasing free-space communications distances and received signal quality, suffer from the reality that they are extremely technically sophisticated and incredibly expensive to design, build and use.

In view of the well recognized and as yet to be discovered advantages of free-space communications, and further in view of the known shortcomings of current free-space communications systems and the technology used to optimize such systems, the inventors have recognized a need for an improved free-space communications system and method that addresses the aforementioned difficulties while providing better performance for less cost.

### SUMMARY OF THE INVENTION

Embodiments of the invention are directed to a free-space communications system, a signal transmission platform for a free-space communications system, and a method for free-space communications, that advantageously provide or have the potential to provide measurable improvements in free-space communications over a turbulent atmospheric transmission path.

A principal feature of all of the embodiments disclosed herein is the generation of a pseudo-non-diffracting communications signal transmission beam, referred to herein as a ‘non-diffracting signal transmission beam’. A realizable embodiment of such a non-diffracting signal transmission beam known in the art is a Bessel beam. The various components and procedures for creating a usable Bessel beam are disclosed, for example, in Lin et al. “Experimental investigation of Bessel beam characteristics,” Applied Optics, 31, 15, pp. 2708-2713 (20 May 1992); Herman and Wiggins, “Production and uses of diffractionless beams,” J. Opt. Soc. Am. A, 8, 6, pp. 932-942 (June 1991); Durnin et al., “Comparison of Bessel and Gaussian beams,” Optics Letters, 13, 2, pp. 79-80 (February 1998); U.S. Pat. No. 4,852,973; U.S. Pat. No. 4,887,885; U.S. Pat. No. 5,349,592; and U.S. Pat. No. 6,552,864, the disclosures of which are herein incorporated by reference in their entireties to the fullest allowable extent under all applicable laws and rules. It is further disclosed in U.S. Pat. No. 4,887,885 that any type of beam to which the Helmholtz generalized wave equation applies can be used to generate a well-defined traveling wave beam substantially unaffected by diffractive spreading. The categories of beams governed by the Helmholtz equation include electromagnetic waves, particle beams, a transverse beam, a longitudinal beam such as an acoustic beam, and others. Although persons skilled in the art will understand that certain frequencies and beam types are more or less suitable for free-space communications applications, the disclosure set forth below will describe illustrative and exemplary embodiments of the invention in terms of a laser beam as representing the general type of radiative energy for both a source signal beam and the non-diffracting signal transmission beam as those terms are used herein. The illustrative and exemplary references to a laser beam, however, are in no way intended to limit the scope of the various embodiments of the invention to laser beams; rather, any suitable form of energy distribution governed by the Helmholtz generalized wave equation, having characteristics suited to a communications signal and convertible to a non-diffracting beam, are included within the scope of the embodiments of the invention.

According to an embodiment, a free-space communications system includes a communications signal transmitter platform that ultimately can generate a particularly specified transmission signal waveform, which, according to the embodiment, is a non-diffracting signal transmission beam. The free-space communications system also includes a communications signal receiver platform that is located along a free-space communications signal transmission path. According to an aspect, the non-diffracting signal transmission beam ultimately generated and transmitted by the signal transmitter platform is a Bessel beam. The Bessel beam can have a zero-order (J_{O}) transverse intensity distribution or, alternatively, may be a higher order Bessel beam. In an illustrative aspect, the non-diffracting signal transmission beam will have a transverse intensity distribution in the form of a central bright spot and at least one concentric annular ring. According to the embodiment, the signal transmitter platform includes a source beam generator and a source beam converter that is optically coupled to the source beam generator. The source beam converter is a device component that can convert a diffractive-type (source) beam (e.g., laser beam having a transverse Gaussian intensity distribution) into a (pseudo) non-diffracting (transmission) beam that will propagate the communication signal over a free-space transmission path. In an exemplary aspect, the source beam generator is a laser, including any of a variety of types of lasers suitable for creating an optical communication signal beam. For an exemplary source laser beam having a transverse Gaussian intensity profile, known non-diffracting beam converters include a beam collimator combined with an axicon, an assembly of spherically aberrating (with or without external collimation) lenses whose errors approximate an axicon, a holographic element, a spatial light modulator configured to produce a Bessel beam, an annular slit, and others. The particular apparatus used to convert the source beam to the non-diffracting signal transmission beam is not a per se element of the embodiments described herein. Depending upon the source beam characteristics (e.g., laser beam intensity), suitable, non-limiting media for coupling the source beam generator to the source beam converter include a free-space optical path and an optical waveguide such as a single mode or a multi mode optical fiber, for example. The signal transmitter platform includes a modulator that can modify the phase and/or the amplitude of the source beam. According to an aspect, the system may include an alignment component that is capable of pointing the non-diffracting signal transmission beam propagation path at the receiver platform with a known degree of precision. In various exemplary aspects, the alignment component may be an opto-mechanical system that includes a Risley prism, kinematically controlled beam steering components, electro-optic or acousto-optic deflectors and other physical and/or optical components implemented alone or in combination, which may be manually or computer controlled to cause the signal transmission beam to remain targeted on the receiver platform despite perturbation of one or both of the transmitter platform and the receiver platform. According to an aspect, the receiver platform will include a demodulator and various optical components that can suitably focus the non-diffracting signal transmission beam onto a receiving plane and into a detector. In an exemplary aspect, the receiver platform detector comprises only a single finite point receiver that is positioned in the receiving plane to receive only a portion of the focused beam. According to a particular aspect, only a portion of the beam that does not include the central bright spot of the beam is detected. In an exemplary aspect, the finite point receiver is an optical fiber having an end positioned to receive the portion of the non-central bright spot of the beam. In an alternative aspect, the detector may comprise a plurality of single finite point receivers, such as a fiber bundle, the ends of which would be positioned to receive only a portion of the non-central bright spot of the focused beam, and which is configured to output a single signal from the input plurality of the bundle. In an aspect, the receiving platform may also include an apodization aperture to selectively limit the distribution of the signal transmission beam entering the receiver.

According to another embodiment, a transmission platform for a free-space communications system includes a source beam generator and a source beam converter configured to convert a diffracting type source beam into a non-diffracting type signal transmission beam, wherein the source beam converter is optically coupled to the source beam generator. Various aspects of the transmission platform are as described above in relation to the free-space communications system embodiment.

According to another embodiment of the invention, a method for operating a communications system over a free-space medium includes the steps of providing a diffracting type communication signal source beam, converting the source beam to a non-diffracting signal transmission beam, propagating the non-diffracting signal transmission beam from a signal transmission platform to a signal receiving platform over a free-space transmission path and detecting the non-diffracting signal transmission beam at the signal receiving platform. According to an exemplary aspect, a modulated Gaussian laser beam is provided as the source beam. The source beam is converted into a Bessel beam as the non-diffracting signal transmission beam. According to an aspect, the Bessel beam may be a zero order Bessel beam, wherein detecting the signal includes the step of detecting only a portion of a concentric annular region of the beam that does not include a central bright region of the beam.

These and other objects, advantages and benefits provided by embodiments of the invention will now be set forth in detail with reference to the detailed description and the drawing figures and as defined in the appended claims.

### BRIEF DESCRIPTION OF THE DRAWINGS

FIG. 1 is a block diagram of a free-space communications system according to an embodiment of the invention;

FIG. 2 is a cross sectional, schematic diagram of a signal receiver according to an embodiment of the invention;

FIGS. 3(a-d) illustrate attributes of a diffracting type (Gaussian) beam at a receiver under conditions of no turbulence to aid in understanding features of the embodied invention;

FIGS. 4(a-d) illustrate attributes of the diffracting type (Gaussian) beam at the receiver under conditions of turbulence to aid in understanding features of the embodied invention;

FIGS. 5(a-d) illustrate attributes of an illustrative non-diffracting type (Bessel) signal beam at a receiver under conditions of no turbulence according to an embodiment of the invention; and

FIGS. 6(a-d) illustrate attributes of the illustrative non-diffracting type (Bessel) signal beam at the receiver under conditions of turbulence according to an embodiment of the invention.

### DETAILED DESCRIPTION OF EMBODIMENTS OF THE INVENTION

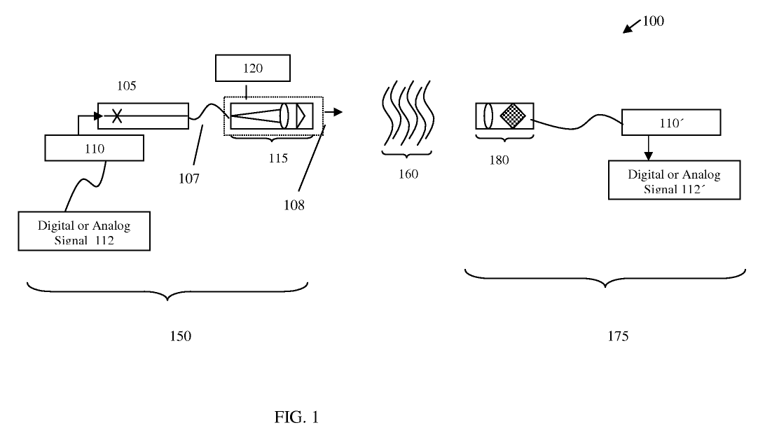

An illustrative embodiment of the invention is directed to a free-space communications system 100 (“the system”) as shown in the block diagram of FIG. 1. The system 100 as shown includes a signal transmitter platform 150 and a signal transmission receiver platform 175 separated by a turbulent free-space transmission medium 160.

The signal transmitter platform 150 is comprised of a source beam generator 105 such as a coherent or semi-coherent laser source (e.g., diode laser, fiber laser, SLD, etc.) that generates a diffracting type beam 107 having a Gaussian transverse intensity distribution. Auxiliary optics (not shown) may be used to condition the output from the source beam generator 105. In an exemplary aspect, the signal laser wavelength is 1.3 micrometers. A modulator 110, driven by a digital or analog signal driver 112, is operatively connected to the laser source. The modulator modifies the phase, amplitude, or both the phase and amplitude of the source signal 107. The modulator does not necessarily impart informational content to the system.

A Bessel beam projector 115, being also a part of the signal transmitter platform 150, is used to convert the diffracting type output from the laser source into a non-diffracting type transmission 108 referred to hereinafter as a Bessel beam. The modulated, diffracting type source signal 107 is input to the Bessel beam projector 115. The transmission medium between the laser source and the Bessel beam projector may be free space or an appropriate waveguide medium. The components of the Bessel beam projector 115 may comprise any of the following exemplary components or systems, or others known in the art, having the capability to modify a Gaussian beam into a Gauss-Bessel beam: a collimator plus axicon assembly; an assembly of spherically aberrating lenses (with internal or external collimation) whose aberrations approximate an axicon; a holographic element; a spatial light modulator configured to produce a Bessel beam; an annular slit assembly; others known in the art. The specific configuration of the Bessel beam projector is not part of the invention per se.

The exemplary signal transmitter platform 150 further includes an alignment mechanism 120. The alignment mechanism is a component or system that can point the Bessel beam 108 with precision at the receiver platform 175 (described in more detail below). The alignment mechanism 120 may typically include an opto-mechanical system such as a Risley prism set, a mechanical stage, or a combination of these or other known components capable of pointing the signal beam 108 with the desired accuracy. The alignment mechanism 120 may be computer controlled via a feedback loop, for example, that is capable of keeping the transmitted signal beam 108 targeted on the receiver despite some finite amounts of perturbation of the transmission and/or receiver platforms due to wind, for example. The specific configuration of the alignment mechanism 120 is not part of the invention per se.

The turbulent medium 160 through which the Bessel beam 108 propagates towards the receiver platform 175 will typically be air or water. The turbulence of the medium will produce distortion in the propagating signal.

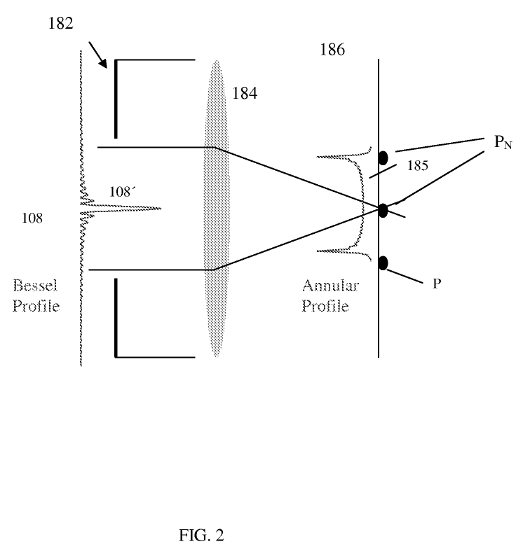

An exemplary receiver 180 of the receiver platform 175 is illustrated in FIG. 2. The exemplary receiver 180 consists of an apodization component 182, such as an iris for example, located in the propagation path of the Bessel beam 108. The iris is the most anteriorly located component of the receiver and is used to select only the central region of the received Bessel beam. The central region may comprise only a portion or all of the central bright spot of the zero-order Bessel function or may include the central bright spot and one or more of the annular rings of the zero-order Bessel function. A focusing lens 184 is located posteriorly to the apodization aperture. The focusing lens focuses the Apodized region 108′ of the Bessel beam in a focal plane 186. As shown in FIG. 2, the focusing lens produces an annular intensity distribution 185 in the focal plane of the lens. A point receiver P is located in the focal plane 186. The point receiver 185 is intended to capture only a sub-region or relatively small portion of the “bright” part of the annulus. In an exemplary aspect, the point receiver is a bare optical fiber suspended such that a free end of the fiber represents the point P₁. The point receiver may similarly be located to receive a portion of any bright area of the beam in the focal plane. By sampling only a sub-region of the focal plane intensity distribution of the received Bessel beam, the variance in the intensity of the beam is likely to be less than the variance would be over the entire beam. In an alternative aspect, a combination of point receivers P_{N} may be positioned in the focal plane and their outputs combined to produce a single output value. For example, a point array receiver could be fashioned and used such that the output represents the sum of the energy in a single annular intensity ring of the Bessel distribution in the focal plane. Similarly, a finite number of point receivers P_{N}; two, for example, could be positioned to receive two portions of an annular intensity ring at 180 degree meridians (or three P_{N} at 120 degree meridians; four P_{N} at 90 degree meridians, and so on), all of the N-outputs which are then combined to produce a single output value. Other known photodetectors may be used alternatively to an optical fiber.

A demodulator 110′, as shown in FIG. 1, is coupled to the receiver 180 output to provide a respective digital or analog signal 112′. The demodulator 110′ may be any appropriate conventional optical demodulator and detector, which may include optical and electrical amplifiers, digitizers, and other known components. The specific configuration of the demodulator 110′ is not part of the invention per se.

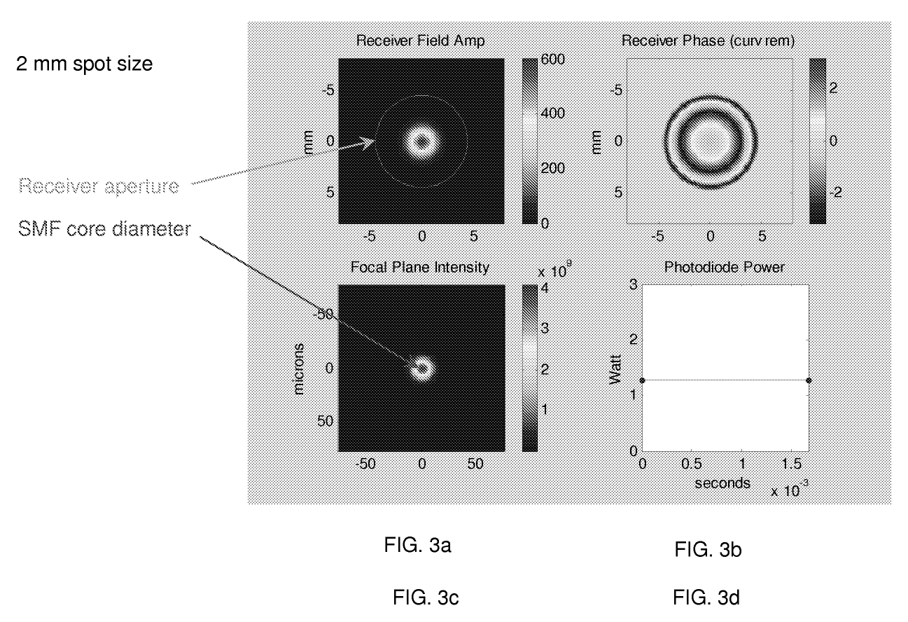

An exemplary comparative performance illustration of the benefits and advantages according to the embodiments of the invention is now presented with reference to FIGS. 3-6. A dual-path experiment was set up in which a laser was used to produce a 1.32μ wavelength Gaussian output beam. The beam was collimated and split into two approximately 1 watt beams traveling along two equal 2 meter paths towards a receiver aperture. The beam in each beam path had a 6 mm transmit diameter and a 9 mm receive diameter. An f/3.3 lens was used to focus the received beams to a 2 mm spot. A SMF-28 optical fiber was positioned in the focal plane. Final output power was measured by a photodiode. One on the optical paths contained two phase screens to simulate a turbulent free space medium.

FIG. 3 shows attributes of the transmitted and received Gaussian beam along the path with no simulated turbulence. The Gaussian beam had a 2.4 m Rayleigh range. FIG. 3a shows the amplitude of the 2 mm beam spot at the receiver aperture. FIG. 3b illustrates the beam phase at the receiver aperture. FIG. 3c shows beam spot intensity at the focal plane as input centered on the SMF-28 fiber. FIG. 3d shows the substantially constant photodiode power over about 1.3 ms.

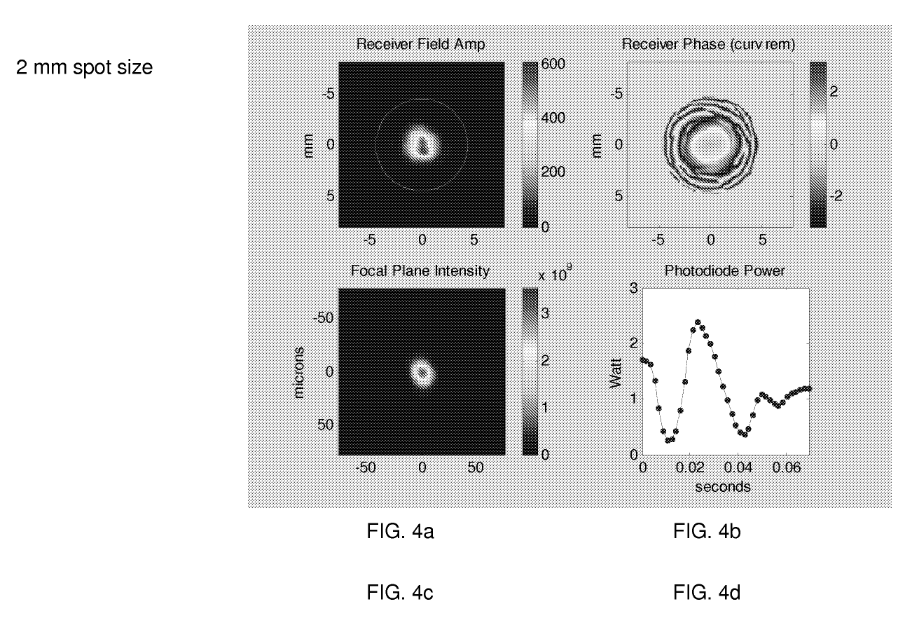

FIGS. 4(a-d) respectively show the attributes of the transmitted and received Gaussian beam along the path with the simulated turbulence. As illustrated in FIG. 4d, the turbulence induces significant power fluctuations in the received beam.

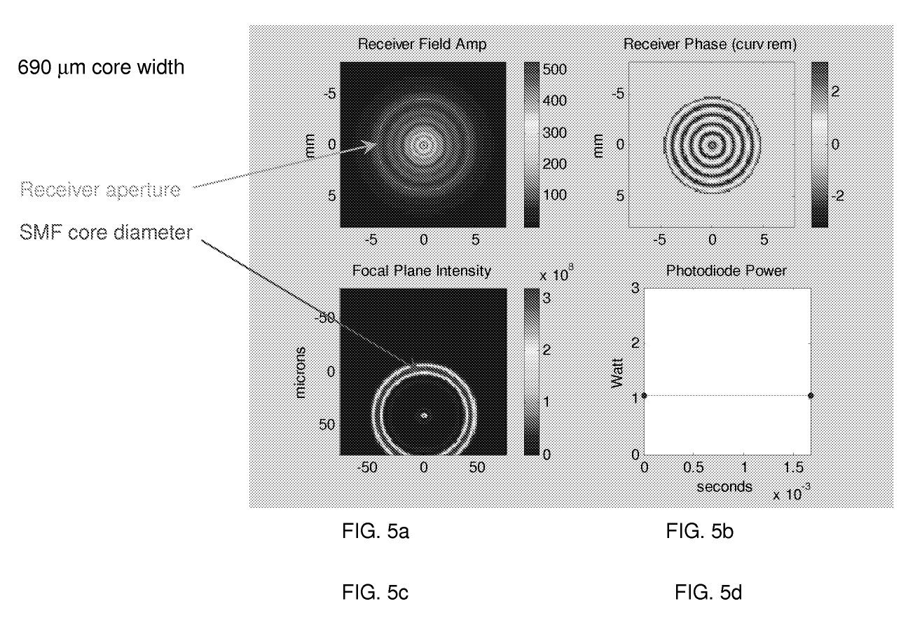

FIG. 5a shows the receiver field amplitude of an unperturbed Bessel beam having a 690μ core diameter. The clipped Bessel beam has a 4.1 m Rayleigh range. FIG. 5b illustrates the beam phase at the receiver aperture. FIG. 5c shows an annular intensity ring of the Bessel beam in the focal plane. The core of the SMF-28 fiber is located in a region of the ring to maximize power coupled into the fiber. FIG. 5d shows the substantially constant photodiode power over about 1.3 ms.

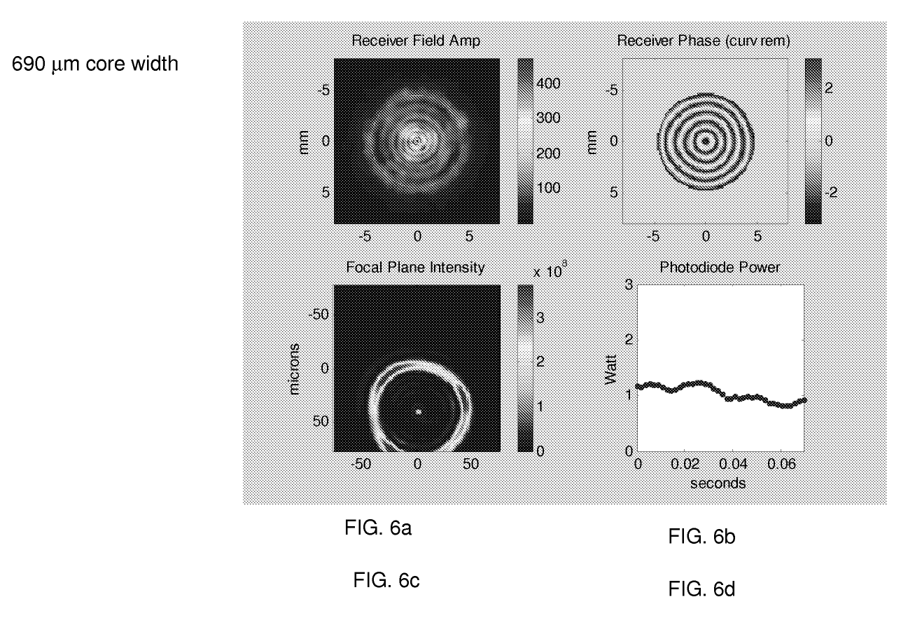

FIGS. 6(a-d) respectively show the attributes of the transmitted and received Bessel beam along the path with the simulated turbulence. As illustrated in FIG. 6d, the turbulence induces relatively small power fluctuations in the received beam.

In summary, Bessel beams and other non-Gaussian non-diffracting beams may improve free space laser communications systems given their improved intensity stability under turbulent conditions. By modifying the signal light source from Gaussian to Bessel or other non-diffracting type beams, intensity stability under turbulence is improved. This passive technique, by virtue of increased intensity stability, may help to maintain bit error rate performance under turbulence.

The foregoing description of the embodiments of the invention have been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A free-space communications system, comprising:
a communications signal transmitter platform that can generate a desired form of a communications transmission signal; and
a communications signal receiver platform located along a free-space communications signal transmission path,
wherein the desired form of the communications transmission signal is a non-diffracting signal transmission beam.

2. The system of claim 1, wherein the non-diffracting signal transmission beam is a Bessel beam.

3. The system of claim 2, wherein the Bessel beam is a zero-order Bessel beam.

4. The system of claim 1, wherein the signal transmitter platform includes a source beam generator and a source beam converter optically coupled to the source beam generator that can convert the source beam into the non-diffracting signal transmission beam.

5. The system of claim 4, wherein the signal transmitter platform further includes a source beam modulator.

6. The system of claim 1, further comprising an alignment component that is capable of aligning the communications signal transmission path to the signal receiver platform.

7. The system of claim 6, wherein the alignment component includes a Risley prism.

8. The system of claim 4, wherein the source beam generator is a laser that generates a source laser beam.

9. The system of claim 4, wherein the source beam generator and the source beam converter are optically coupled via a free space medium.

10. The system of claim 4, wherein the source beam generator and the source beam converter are optically coupled via an optical waveguide.

11. The system of claim 10, wherein the optical waveguide is a single mode fiber.

12. The system of claim 8, wherein the source laser beam has a Gaussian cross sectional energy profile.

13. The system of claim 4, wherein the source beam converter includes a collimator optically coupled with an axicon.

14. The system of claim 4, wherein the source beam converter includes at least one lens having a spherical aberration error that approximates an aberration error of an axicon.

15. The system of claim 4, wherein the source beam converter includes a holographic element.

16. The system of claim 4, wherein the source beam converter includes a spatial light modulator configured to produce a Bessel beam from a Gaussian beam.

17. The system of claim 4, wherein the source beam converter includes an annular slit.

18. The system of claim 2, wherein the Bessel beam has a transverse intensity profile comprising a central bright spot and one or more surrounding bright annuli in a receiving plane of the system.

19. The system of claim 1, wherein the receiver platform includes only a single finite point receiver positioned to receive only a portion of the beam in a receiving plane of the system.

20. The system of claim 19, wherein the receiver platform includes an anteriorly positioned apodization aperture.

21. The system of claim 19, wherein the receiver platform further includes a focusing lens, wherein the receiving plane is a focal plane of the lens.

22. The system of claim 21, wherein the receiver platform includes an anteriorly positioned apodization aperture.

23. The system of claim 22, wherein the apodization aperture is an adjustable iris.

24. The system of claim 1, wherein the receiver platform includes an anteriorly positioned apodization aperture.

25. The system of claim 19, wherein the single finite point receiver is an optical fiber having an end positioned to receive only the portion of the beam at the receiving plane.

26. The system of claim 1, wherein the receiver platform includes a plurality of finite point receivers that are operationally coupled to produce a single output.

27. The system of claim 26, wherein the receiver platform includes an anteriorly positioned apodization aperture.

28. The system of claim 27, wherein the apodization aperture is an adjustable iris.

29. The system of claim 26, wherein the receiver platform further includes a focusing lens, wherein the a receiving plane is a focal plane of the lens.

30. The system of claim 29, wherein the receiver platform includes an anteriorly positioned apodization aperture.

31. The system of claim 30, wherein the apodization aperture is an adjustable iris.

32. The system of claim 18, wherein the receiver platform includes a plurality of finite point receivers that are operationally coupled to produce a single output that represents a sum of the energy only in the one or more annuli surrounding the central spot.

33. The system of claim 5, further including a demodulator coupled to the receiver platform.

34. A transmission platform for a free-space communications system, comprising:
a source beam generator that generates a diffracting type source beam; and
a source beam converter configured to convert the source beam in to a non-diffracting type signal transmission beam, optically coupled to the source beam generator.

35. The transmission platform of claim 34, wherein the source beam converter and the source beam generator are optically coupled by a free-space medium.

36. The transmission platform of claim 34, wherein the source beam converter and the source beam generator are optically coupled by an optical wave guide.

37. The transmission platform of claim 36, wherein the optical wave guide is a single mode fiber.

38. The transmission platform of claim 34, wherein the non-diffracting signal transmission beam is a Bessel beam.

39. A method for operating a communications system over a free-space medium, comprising:
providing a diffracting type communications signal source beam;
converting the communications signal source beam to a non-diffracting type signal transmission beam for transmission over a free-space transmission path between a signal transmission platform and a signal receiving platform of the communications system;
propagating the non-diffracting signal transmission beam over the free-space transmission path; and
detecting the non-diffracting signal transmission beam at the signal receiving platform of the communications system.

40. The method of claim 39, wherein providing a communications signal source beam comprises providing a coherent laser beam having a Gaussian transverse intensity profile.

41. The method of claim 40, wherein converting the communications signal source beam to a non-diffracting signal transmission beam comprises providing a Bessel beam generator configured to convert the Gaussian laser beam to a Bessel beam.

42. The method of claim 41, wherein detecting the signal transmission beam comprises focusing the Bessel beam at the receiving platform and detecting only a non-central portion of the focused Bessel beam in a receiving plane of the receiving platform.

43. The method of claim 42, comprising providing only a single finite point receiver for detecting the signal transmission beam.

44. The method of claim 43, wherein the single finite point receiver is an optical fiber having an end positioned to receive the only a non-central portion of the focused Bessel beam.

45. The method of claim 42, comprising providing an array of single finite point receivers for detecting the signal transmission beam, wherein the array of receivers are configured to produce a single output.
